(19) United States
(12) Patent Application Publication
(10) Pub. No.: US 2024/0015477 A1
(43) Pub. Date: Jan. 11, 2024

(54) Method and Apparatus of An Automated Safety Response System in a Self-organizing, multi-networked cooperative NvisiLink Mesh with Echo Positioning

(71) Applicants: John Terry, Annandale, VA (US); Erik Vadersen, Falls Church, VA (US)

(72) Inventors: John Terry, Annandale, VA (US); Erik Vadersen, Falls Church, VA (US)

(21) Appl. No.: 18/219,192

(22) Filed: Jul. 7, 2023

Related U.S. Application Data
(60) Provisional application No. 63/358,902, filed on Jul. 7, 2022.

(51) Int. Cl. H04W 4/02; H04B 1/10; H04R 1/40; H04R 3/00

(52) U.S. Cl. CPC H04W 4/023; H04B 1/1081; H04R 1/406; H04R 3/005; H04W 84/18

(57) ABSTRACT

The present invention teaches the implementation for a system of networked heterogenous signal capture and analysis sensor-enabled devices tethered in a cooperative multi-protocol wireless local area network (WLAN) providing an automated safety monitoring and response services during an active shooter situation. The present invention describes a method to leverage the standard sensors on most smartphones into a real-time swarming of localized tracking, monitoring and guidance networked to direct people to identified safe zones in the covered build and public venues. The system utilizes multi-device real-time two-way positioning/ranging with acoustic based source geo-location algorithm to pinpoint danger regions within the coverage area. The response system described in this invention activates automatically upon detection of discharge of any firearm in the protected area without manual intervention.

### FIELD OF INVENTION

This invention relates to an automated echo positioning safety response system operating within multi-networked cooperative wherein information is transmitted using a digital chaos signature in mesh network.

### BACKGROUND OF INVENTION

A wireless communication device in a communication system communicates directly or indirectly with other wireless communication devices. For direct/point-to-point communications, the participating wireless communication devices tune their receivers and transmitters to the same channel(s) and communicate over those channels. For indirect wireless communications, each wireless communication device communicates directly with a central controlling entity such an associated base station and/or access point via an assigned channel.

Each wireless communication device participating in wireless communications includes a built-in radio transceiver (i.e., transmitter and receiver) or is coupled to an associated radio transceiver. Typically, the transmitter includes at least one antenna for transmitting radiofrequency (RF) signals, which are received by one or more antennas of the receiver. When the receiver includes two or more antennas, the receiver may select one of antennas to receive the incoming RF signals based on the received signal strength at each antenna. This type of wireless communication between the transmitter and receiver is known as a single-output-single-input (SISO) communication.

Acoustics is defined by ANSI/ASA S1.1-2013 as “(a) Science of sound, including its production, transmission, and effects, including biological and psychological effects. (b) Those qualities of a room that, together, determine its character with respect to auditory effects.” The study of acoustics revolves around the generation, propagation and reception of mechanical waves and vibrations. The five steps defining any acoustical event or process 100 are depicted in FIG. 1. There are many kinds of causes 101, both natural and volitional. There are many kinds of transduction processes 102 that convert energy from some other form into sonic energy, producing a sound wave 103. There is one fundamental equation that describes sound wave propagation, the acoustic wave equation, but the phenomena that emerge from it are varied and often complex. The wave carries energy throughout the propagating medium. Eventually this energy is transduced 104 again into other forms, in ways that again may be natural and/or volitionally contrived. The final effect 105 may be purely physical, or it may reach far into the biological or volitional domains. The five basic steps depicted in FIG. 1 are found equally well whether we are talking about an earthquake, a submarine using sonar to locate its foe, or a band playing in a rock concert.

A transducer is a device for converting one form of energy into another. In an electroacoustic context, this means converting sound energy into electrical energy (or vice versa). Electroacoustic transducers include loudspeakers, microphones including acoustic sensors with an electrical transducer, particle velocity sensors, hydrophones and sonar projectors. These devices convert a sound wave to or from an electric signal. The most widely used transduction principles are electromagnetism, electrostatics and piezoelectricity. The transducers in most common loudspeakers (e.g., woofers and tweeters), are electromagnetic devices that generate waves using a suspended diaphragm driven by an electromagnetic voice coil, sending off pressure waves. Electret microphones and condenser microphones employ electrostatics—as the sound wave strikes the microphone's diaphragm, it moves and induces a voltage change. The ultrasonic systems used in medical ultrasonography employ piezoelectric transducers.

Security, surveillance and monitoring systems are not new and have been around for decades. Automated transmission of wireless alerts for these types of systems exists today. Activation or triggers for these systems exist based on sound, breaking of electronic contacts at entry points to the protection building, artificial intelligence classification based on imagery data. These systems today can be broadly categorized as static, reactive systems. By that, we mean an event trigger (causes) a series of predetermined number of responses (static effect) to the event as depicted in FIG. 3. What is needed is an iterative monitoring and alert system wherein single or multiple triggers are automatically assisted by fixed local sensors and monitors (401, 402) as shown in FIG. 4 but aided by smart devices in the vicinity (501, 502, 503, . . . , 5“n”) connected to cooperatively network—with subnets A, B, and C in FIG. 5—for dynamic responses (dynamic effects) such as until the situation is resolved.

The principle of ranging works by calculating by measuring the time difference for an energy signal travel from one location to another. The energy signal can take many forms as sound, light or rf. FIG. 2 shows an exemplary example of ranging 200 using wideband rf signals. Flight time 201 is the actual time it takes the rf wave to travel between devices. The turn-around time 202, device-dependent measurement error, is the time it takes the device to receive and process the incoming rf pulse to register its arrival and respond with its own transmit rf pulse in the return direction.

Ultrawideband (UWB) technologies have recently seen a resurgence in commercial sectors through the FiRa Consortium (firaconsortium.org) for use cases such as access control, location-based services, and device-to-device services. UWB offers fine ranging and secure capabilities and operates in the available 6-9 GHz spectrum. UWB is defined by the FCC and International Telecommunication Union Radiocommunication Sector (ITU-R) as any technology transmitting information in bandwidths greater than 500 MHz or 20% of the arithmetic center frequency. A UWB radio uses transmissions at various frequencies to mitigate multipath propagation since some of the frequencies have a line-of-sight trajectory while other indirect paths have longer delays. These UWB radios operated in a cooperative symmetric two-way ranging technique.

Research has shown commercial UWB modules' ranging accuracy is susceptible to severe degradation in non-line of sight (NLOS), high multipath and electronic attack conditions. Time of flight calculations are predicated on the assumption that the detected pulse results from the signal from the transmitter along the shortest direct path between it and the receiver. FIG. 7 shows the real transmit signal (710) and the real received signal (720) case with this condition is true (730) and false (740) showing severe degradation. A critical improvement over the state of the art would provide ranging accuracy in NLOS, high multipath or the presence of electronic.

Generally speaking, transmission systems compliant with the IEEE 802.11x (e.g., 802.11a/g/n/p/ac/ah/ax) or WiFi 4-7 physical layer (PHY Layer) specifications achieve their high data transmission rates using Orthogonal Frequency Division Modulation (OFDM) encoded symbols mapped up to a 64-quadrature amplitude modulation (QAM) multi-carrier constellation. In a general sense, the use of OFDM divides the overall system bandwidth into a number of frequency sub-bands or channels, with each frequency sub-band being associated with a respective sub-carrier upon which data may be modulated. Thus, each frequency sub-band of the OFDM system may be viewed as an independent transmission channel within which to send data, thereby increasing the overall throughput or transmission rate of the communication system.

Transmitters used in direct sequence spread spectrum (DSSS) wireless communication systems such as those compliant with commercial telecommunication standards WCDMA and CDMA 2000 perform high-speed spreading of data bits after error correction, interleaving and prior to symbol mapping. Thereafter, the digital signal is converted to analog form and frequency translated using conventional RF up conversion methods. The combined signals for all DSSS signals are appropriately power amplified and transmitted to one or more receivers shown in 600 in FIG. 6.

Likewise, the receivers used in the wireless communication systems that are compliant with the aforementioned PHY Layer of 802.11x standards and LTE 4G/5G standards typically include an RF receiving unit that performs RF down conversion and filtering of the received signals (which may be performed in one or more stages), and a baseband processor unit that processes the OFDM encoded symbols bearing the data of interest. The digital form of each OFDM symbol presented in the frequency domain is recovered after baseband down converting, conventional analog to digital conversion and Fast Fourier Transformation of the received time domain signal. Whereas receivers used for reception for DSSS must de-spread the high signal after baseband down converting to restore the original information signal band but yields a processing gain equal to the ratio the high-speed signal to information bearing signal. Thereafter, the baseband processor performs demodulation and frequency domain equalization (FEQ) to recover the transmitted symbols, and these symbols are then processed with an appropriate FEC decoder—e.g., a Viterbi decoder, LDPC decoder—to estimate or determine the most likely identity of the transmitted symbol. The recovered and recognized stream of symbols is then decoded, which may include deinterleaving and error correction using any of several known error correction techniques, to produce a set of recovered signals corresponding to the original signals transmitted by the transmitter.

To further increase the number of signals which may be propagated in the communication system and/or to compensate for deleterious effects associated with the various propagation paths, and to thereby improve transmission performance, it is known to use multiple transmission and receive antennas 650 of FIG. 6 within a wireless transmission system. Such a system is commonly referred to as a multiple-input, multiple-output (MIMO) wireless transmission system and is specifically provided within the 802.11x IEEE Standard. As is known, the use of MIMO technology produces significant increases in spectral efficiency, throughput and link reliability, and these benefits generally increase as the number of transmission and receive antennas within the MIMO system increases.

In addition to the frequency channels created by the use of OFDM, a M IMO channel formed by the various transmissions and receive antennas between a particular transmitter and a particular receiver includes a number of independent spatial channels. As is known, a wireless MIMO communication system, refer FIG. 8, can provide improved performance (e.g., increased transmission capacity) by utilizing the additional dimensionalities created by these spatial channels for the transmission of additional data. The spatial channels of a wideband MIMO system may experience different channel conditions (e.g., different fading and multi-path effects) across the overall system bandwidth and may therefore achieve different signal-to-noise ratio (SNRs) at different frequencies (i.e., at the different OFDM frequency sub-bands) of the overall system bandwidth. Consequently, the number of information bits per modulation symbol (i.e., the data rate) that may be transmitted using the different frequency sub-bands of each spatial channel for a particular level of performance may differ from frequency sub-band to frequency sub-band. Whereas DSSS signal occupies the entire channel band, the number of information bits per modulation symbol (i.e., the data rate) that may be transmitted using the different chaos sequence for each spatial channel for a particular level of performance.

The continual reliance on single access systems creates self-interference which leads to increased latency through idleness and/or retransmission. This remains a critical operational gap in real-time detection and monitoring systems. Data should be reliably transmitted and quickly as possible to maintain accurate timing information. In a time difference of arrival system, whether it be acoustic, rf, or light, the time of arrival of the signals as detected between devices contains errors be it from external interference or systematic operational use. In a trigger/event-based emergency alert system, waiting to gain access to wireless channel to perform ranging estimates can lead to erroneous estimates of positioning information at critical junctures. What is needed is a simultaneous multiple access wireless network to perform distributed relative positioning estimations based on concurrent time-difference of arrivals between pairs of devices with at least one other independent measurement to compute absolute positioning.

There remains a need to exploit the myriad of standard sensors available on today's smartphone (including mics), with two-way fine and coarse ranging, and distributed AI mesh network into a full-scale monitoring and evacuation system for public use.

### SUMMARY OF INVENTION

The present invention teaches improvements in monitoring and evacuation methods and systems during an active shooter situation not found in the prior art. The broad steps for practicing the system are outlined in FIG. 11. The monitoring and evacuating system 1100 is automatically initiated upon detection of unique signal containing tonal and broadband noise component features which are typical of gunfire in real-time (Step 1110). The specific mixture of the tonal and broadband noise like feature are common due to the noise generated by the firing mechanism. The noise from the firing mechanism is distinctive from other loud noises such it may be used to train a deep learner neural network (DNN) engine (Step 1120). Classification of captured acoustics from microphones or other sound transducers as gunfire triggers a source localization process (Step 1130), which begins with sending a NvisiLink beacon as soon as electronically possible for each capable device within in listening range of the sound. The NvisiLink network of devices performs simultaneous two-way coarse ranging between pairs of devices active in network (Step 1140). Further the invention describes a transmit baseband processor unit configured to wirelessly transmit ranging beacon in response as part of automated echo positioning safety response system.

The NvisiLink safety response network according to this invention is comprised of at least one sound capture capability per device, optionally a video recording device, at least two digital chaos enabled communication devices, at least one known fixed device position per coverage area for fine ranging and at least one other wireless network working cooperatively with a NvisiLink Mesh (Step 1150). The NvisiLink safety response network shall be capable of real-time position and ranging based on both acoustic and rf signatures without dependencies on off board remote processing. In one exemplar aspect, operating within multi-networked cooperative NvisiLink Mesh network. In one aspect, the invention describes efficient generation of digital chaos sequence for despreading, demodulated, RF chaos spread spectrum signal that does not drift in relatively sampling time from the originating transmitter or transmitters. Digital chaos enabled systems including digital chaos sequencing and digital chaos signatures are well known and are disclosed in U.S. Pat. Nos. 10, 574, 277; 10,277,438; 9,966,991; 9,479,217 and 8,873,604.

An NvisiLink Mesh network is a wireless communication network where information is transmitted and received using a digital chaos signature. The safety response system is comprised of at least one sound recording device, at least two digital chaos enabled communication devices, and at least one other wireless network working cooperatively with a NvisiLink mesh network. The safety response system shall be capable of real-time position and ranging based on both acoustic and rf signatures without dependencies on off board remote processing.

Similarly to OFDM processing, a multi-code NvisiLink system is comprised of orthogonal high-speed chaos spreading codes transporting independent modulated data, which can be used to increase the overall throughput or transmission rate over a single stream SISO system. In general, high-speed “spreading signals” belong to the class of signals referred to as Pseudo Noise (PN) or pseudo-random signal. This class of signals possesses good autocorrelation and cross-correlation properties such that different PN sequences are nearly orthogonal to one other. The autocorrelation and cross-correlation properties of these PN sequences allow the original information bearing signal to be spread at the transmitter and recovered at the receiver.

Additionally, in exemplary embodiments of this invention, spatial discrimination combined with DSSS is used to combat false detection peak in NLOS, high multipath, or electronic attack 650 in FIG. 6. This application describes several improvements over the state of the art in two-way position location and ranging techniques. In one embodiment of this invention, we extend the two-way ranging to multi-radio concurrent ranging within a cooperative mesh network for finest and coarse location capabilities. In a cooperative multi-radio ranging environment, each radio determines the two relative positions to other active radios in the mesh network by performing traditional two-way ranging technique-based flight time between radios for coarse and fine. The time of flight is calculated by taking half the difference between the total round-trip time (t_{round-trip}, 202) and turn-around (t_{turn-around}, 203) time as illustrated in FIG. 2. Coarse ranging estimates between all pairs nodes are performed using a NvisiLink Mesh network. The procedure is repeated using fine ranging using FiRa compliant devices, UWB devices as defined by the FCC and ITU, or other very broadband radio protocol (500 MHz or greater). What is needed is a means for improving the accuracy for all nodes as the number of numbers participating in the ranging increases. In one embodiment of this invention, each node runs a local AI navigation fusion engine that resolves ambiguities and errors in coarse and fine position locations (referred to as tags, tag 1 and tag 2 in FIG. 4) using known fixed positions (referred to as anchors) with a co-located motion sensor system with orientation of the sensors.

Yet another improvement over the state of the art is the lower latency for increased accuracy in the range determination resulting from the present invention. Traditional methods to calculate all the ranges between all nodes in the mesh network equal the number of unique pairs that can be formed from M nodes. This is the third binomial coefficient in the binomial formula. For example, of a four-radio mesh network (i.e., M=4), the third binomial coefficient is equal to 4!/(2!*2!)=6. Each two-way ranging is performed sequential. As the size of the mesh network grows, the accuracy for earlier range estimates may no longer be valid when the later pairs of nodes are calculated. What is needed is an improvement over the state of the art in ranging estimation methods that use mesh networking for increased accuracy of the range determination and achieve low latency by performing multiple simultaneous ranging concurrently.

In one embodiment, as shown with reference to FIG. 9 and FIG. 10, at least one other independent measurement is used to compute known absolute position by non-GPS means (1010, 1030, 1040) of one of the devices performing two-way ranging calculations. In an exemplary implementation of the invention, architectural building information 900 is used to locate ranging devices fixed emitters 910, 920 and 930 relative one to the other. The location of one of the fixed emitter 910 is known a priori to the two-way ranging procedure and remains fixed throughout the ranging estimation. In yet another embodiment, artificial intelligence (AI) analysis of video feed 1010 along with architectural/building information 900 provides the absolute position information at least an order magnitude more accurate than the sensitivity of the two-ranging estimates. For example, if the precision of the ranging estimates is ±30 centimeters (cm), then AI estimates for use as a priori known locations must be accurate to ±3 centimeters of its true location. In a preferred embodiment, at least one other independent measurement is the known from absolute position by GPS 1050 and cellular network timing of one of smart devices co-located with two-way ranging devices. Another improvement over the start of the art in real-time positioning taught in this invention is the use of sensor orientation of ranging devices within a distributed mesh network with localized AI sensor fusion 1000 calculation on each device. Real-time positioning apparatus useful with this invention may be conventional components capable of determining real-time position using one of GPS, Wi-Fi Bluetooth, etc. By real-time relative positioning, what is meant is that the real-time position of a first item may be measured with respect to a second item.

In another aspect of the invention communications devices within multi-networked cooperative NvisiLink Mesh network establishes a common reference clock or time reference. For example, devices equipped with GPS could use GPS time as a common time reference. Another common time reference might be derived from a cellular to which the communication devices is connected. A common reference time is an important aspect in this invention to establish relative time delays experienced by different communication devices for the same observed or experienced event.

In another aspect of the invention, a physical event serves as a cause for generation mechanism (initiated transduction) for a physical phenomenon as depicted in FIG. 4. The transduction propagates over a dispersive medium until it reaches a transduction receptor connected to a baseband receive processor unit. The baseband receive processor units produces an effect such as, but not limited to, audible alert, flashlight turn on, phone vibrate, transmission predetermined digital chaos sequences (reserved software “SOS” beacons) on a connected mobile connection devices such as a smartphone or tablet.

In another aspect of the invention, a receiving transductor coupled to a receive baseband processor embeds its GPS coordinate, any navigational sensor data (e.g., heading, bearing inertial, pressure, orientation, etc.), and relative time in the common reference time system onto predetermined digital chaos sequences and send the information over the wireless medium thru a transmit baseband unit coupled to at least one antenna. The at least one antenna is responsive to at least one radio frequencies band within reserved banks of operational radiofrequencies band the NvisiLink cooperative network has dedicated for emergency response to cause events.

In another aspect of the invention, there is a known and fixed relationship between the reception time of multiple transduction reception and associated information embedded digital chaos sequence transmission time.

In another aspect of the invention illustrated for example in FIG. 5, a central controlling communication device decodes the information data embedded digital chaos sequence and notes the time difference of arrival for all arriving signals with a fixed interval of time. One interval of time might be 200 milliseconds, 10 seconds, or one minute to help classify the type of cause such a single action fire from a revolver, to semi-automatic pistol, to an automatic rifle.

In other aspects of the invention depicted for example in FIG. 10, the central controlling communication device processes decoded information data which might include navigational sensor data, ranging information with a deep learning neural network (DNN) 1200 shown in FIG. 12 for tracking and geolocation of the source of the cause and receptors and effect generation units within the multi-protocol cooperative NvisiLink mesh network 1030.

In yet another aspect of the invention illustrated for example in FIG. 13, the DNN computes and overlays geolocation on graphical representative of the area in the immediate vicinity of the cause. One graphical representation such as depicted in FIG. 9 might be a floor plan for the building in which the cause occurred. Additionally, the overlaid geolocation is distributed amongst all active members wireless communication devices (such smartphones, tablets, etc.) of the multi-protocol cooperative NvisiLink extended network. The multi-protocol cooperative NvisiLink extended network might include networks operating on FirstNet used by first responder or any bands identified by the Federal Communications Commission (FCC) for Public Safety.

In still another aspect, fixed emitters (910, 930) are sparsely position throughput the structure of interest 900 such as schools, malls, and library. The precise location of at least two fixed emitters is known to each central controlling DNN processor.

In preferred embodiment of the invention, the central controlling entity is a dual operation IEEE 802.11x access point with digital chaos capabilities for mesh networking with multi-device simultaneous ranging computations via safety on software “SOS” beacons.

In alternative embodiment of the invention, the central controlling entity is any mobile device capable of transmitting and receiving information bearing digital chaos sequence with gateway access to the Public Safety network. Further, mobile device must have DNN tracking capability and ranging capabilities.

### BRIEF DESCRIPTION OF DRAWINGS

A more complete understanding of the present invention may be derived by referring to the various embodiments of the invention described in the detailed descriptions and drawings and figures in which like numerals denote like elements, and in which:

FIG. 1 illustrates the sequential relationship occurring when a cause event triggers a chain reaction that initiates a generation mechanism (via transmitting transduction device) that traverse a medium as a propagating wave of energy to be received by a receiving transduction device.

FIG. 2 depicts the key elements of involved in range calculation based on propagating waves and its known speed through the medium between transducing devices.

FIG. 3 shows the interaction between a Map Reference and fusion of navigational sensor data to provide accurate distributed timing information to communication devices connected to smartphones

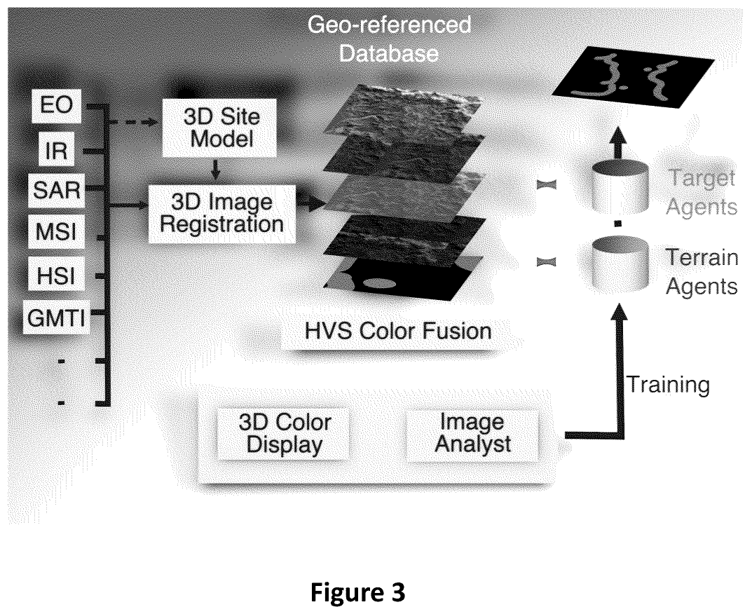

FIG. 4 illustrates multiple two-way ranging between tags of unknown positions with an anchor of known position;

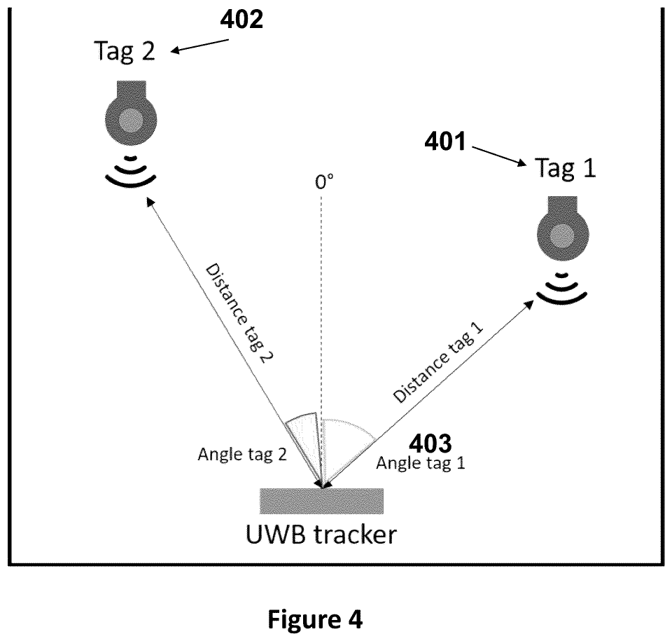

FIG. 5 is an exemplary diagram for NvisiLink mesh network with cluster heads labeled with numbers.

FIG. 6 is an exemplary example of non-interfering concurrent signals of the wireless medium in accordance with various embodiments of the invention;

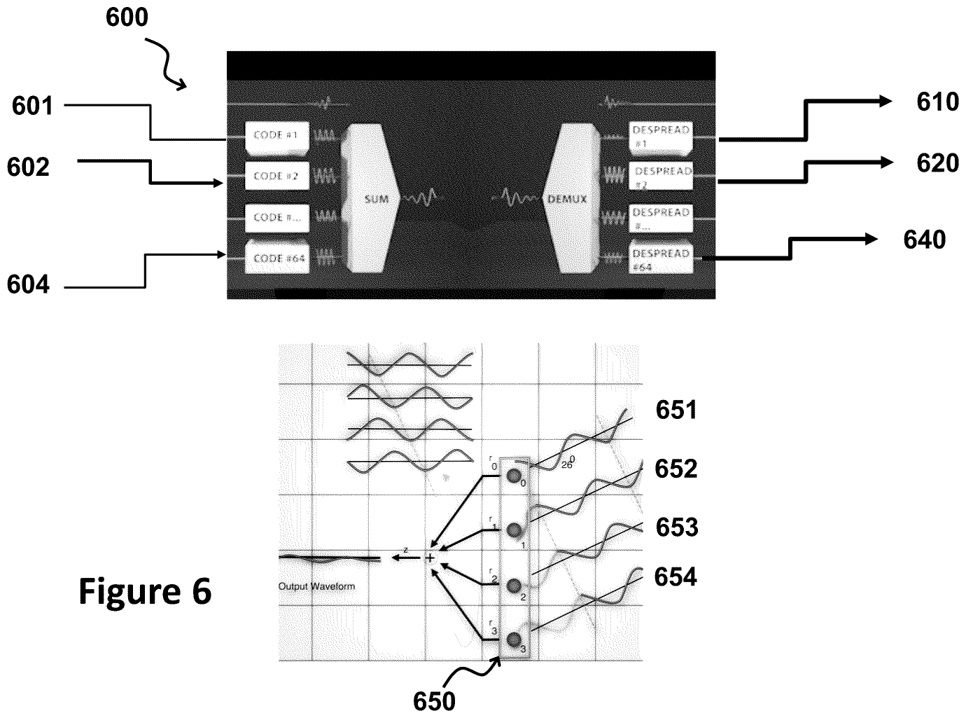

FIG. 7 is an exemplary example of false peaks due to multipath during two-way ranging in accordance with various embodiments of the invention;

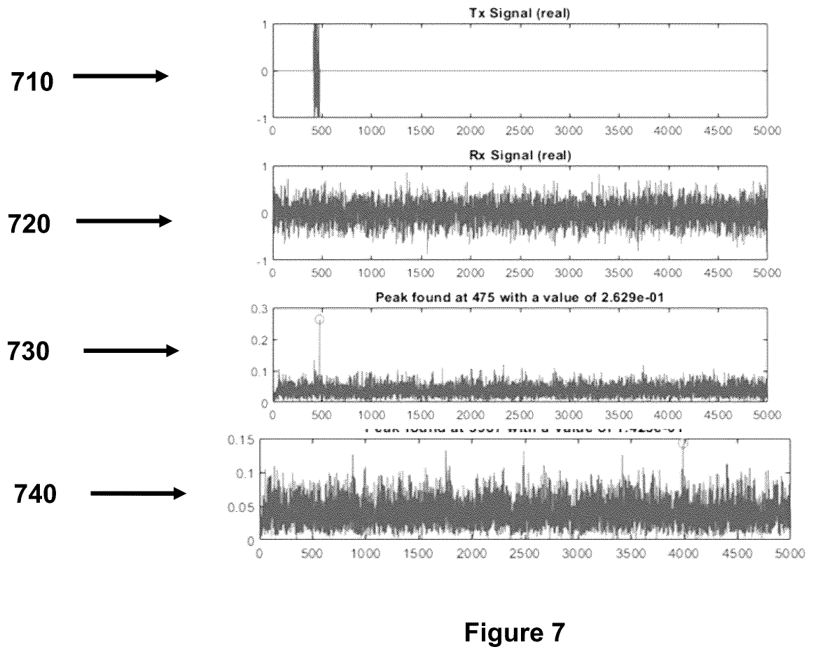

FIG. 8 is an exemplary implementation of MIMO unit, in accordance with various embodiments of the invention;

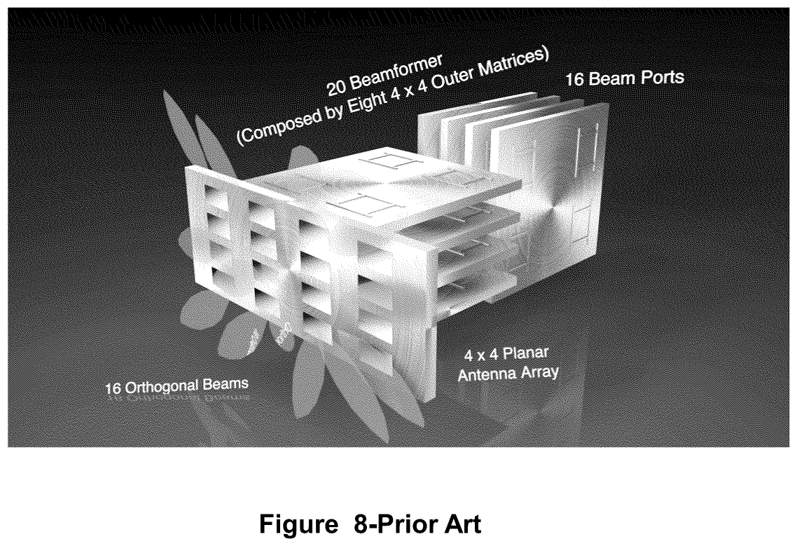

FIG. 9 is an exemplary floorplan of a typical coverage, in accordance with various embodiments of the invention;

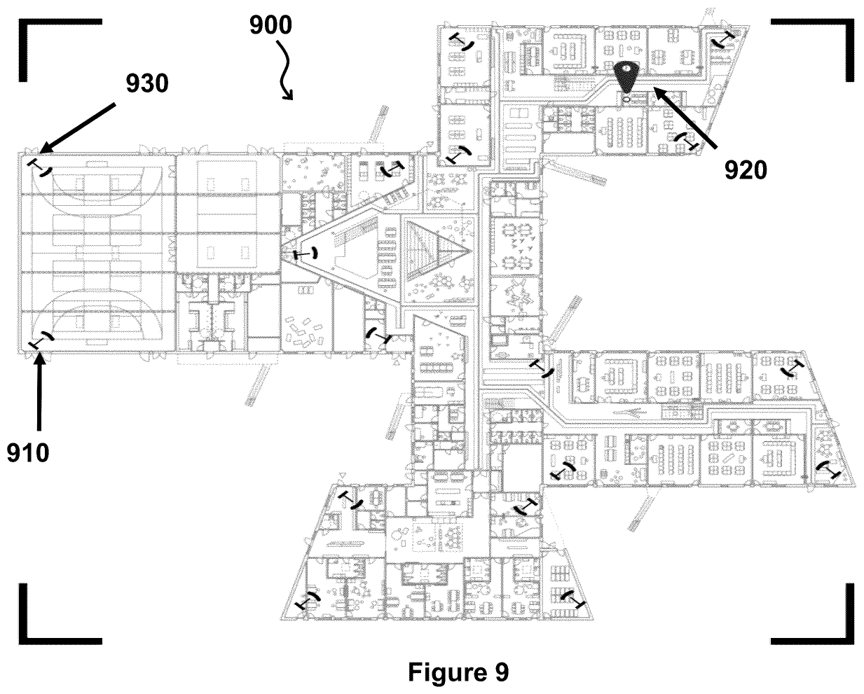

FIG. 10 is an exemplary example of components of a sensor fusion engine that help eliminates false peak triggers due to multipath, in accordance with various embodiments of the invention;

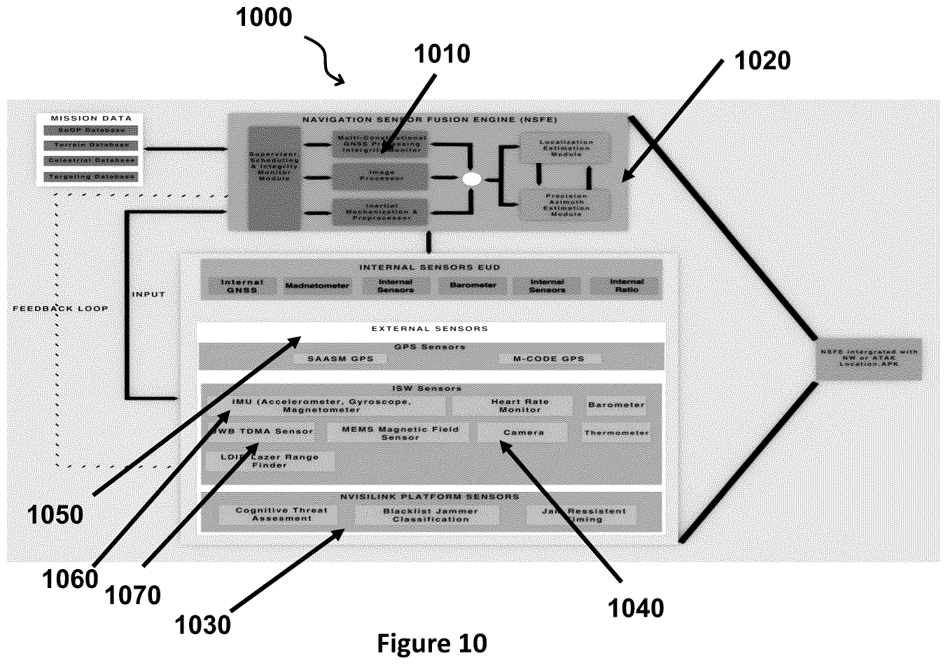

FIG. 11 is an exemplary process flow of expected sequence and acoustic geolocation procedure during an active scenario, in accordance with various embodiments of the invention;

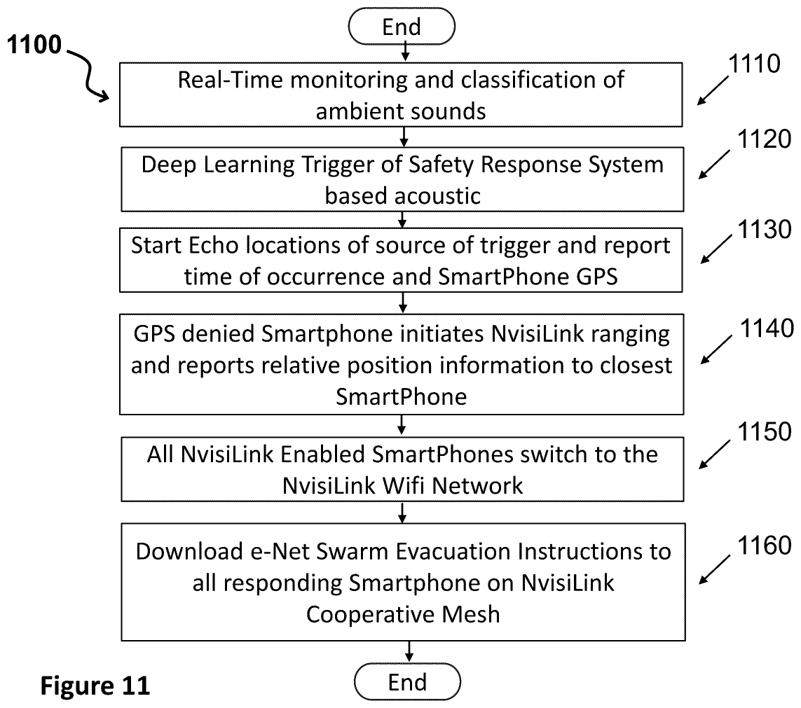

FIG. 12 is a deep learning neural network structure for analytics, classification, and training, in accordance with various embodiments of the invention;

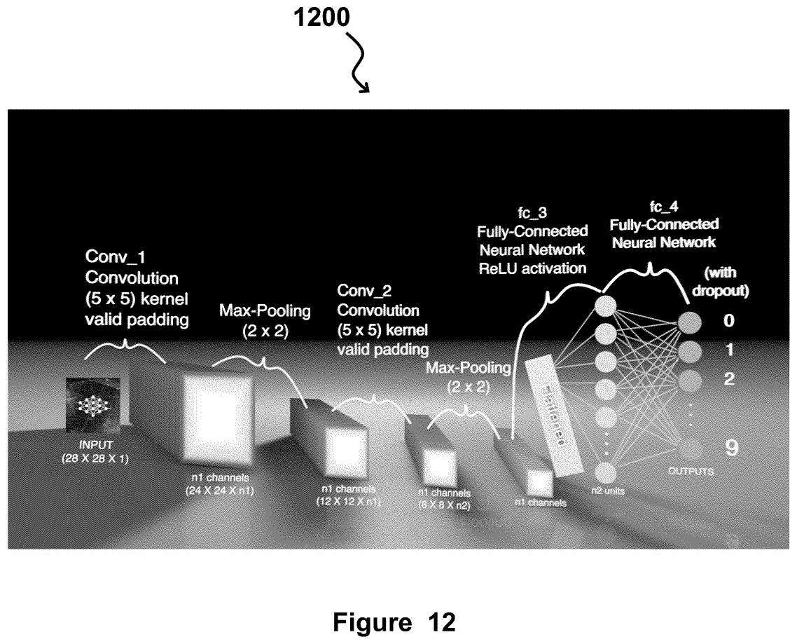

FIG. 13 is an exemplary illustration of swarm movement of smartphone holders, displayed on a downloaded digital map of the type depicted in FIG. 9 being directed to safe zone away from shooter locations.

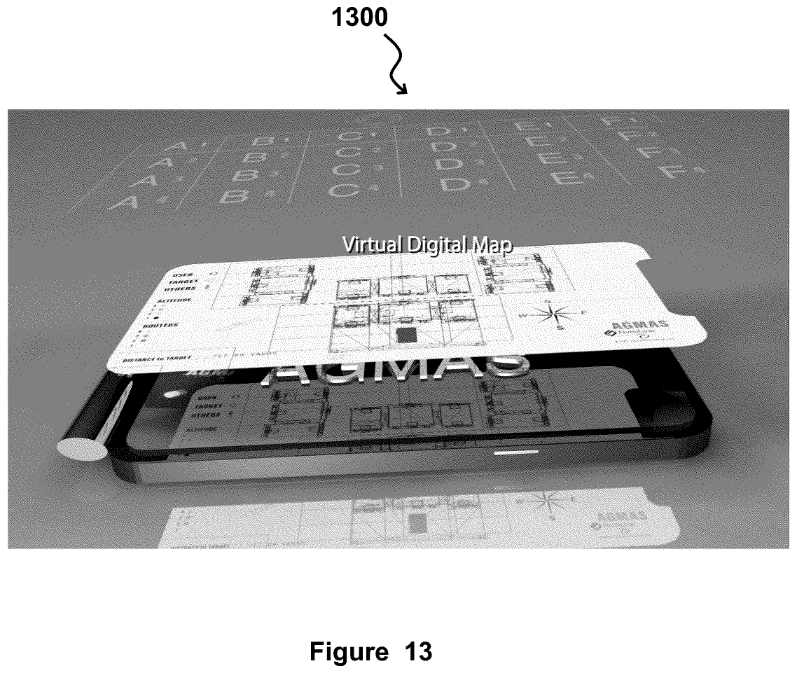

### DETAILED DESCRIPTION

The detailed description of exemplary embodiments of the invention herein refers to the accompanying drawing and flowchart, which show the exemplary embodiment by way of illustration and its best mode. While these exemplary embodiments are described in sufficient detail to enable those skilled in the art to practice the invention, it should be understood that other embodiments may be realized, and that logical and mechanical changes may be made without departing from the spirit and scope of the invention. Thus, the description herein is presented for purposes of illustration only and not of limitation. For example, the steps recited in any of the method or process descriptions may be executed in any order and are not limited to the order presented.

The present invention may be described herein in terms of functional block components and various processing steps. It should be appreciated that such functional blocks may be realized by any number of hardware and/or software components configured to perform the specified functions. For example, the present invention may employ various integrated circuit (IC) components (e.g., memory elements, processing elements, logic elements, look-up tables, and the like), which may carry out a variety of functions under the control of one or more microprocessors or other control devices. Similarly, the software elements of the present invention maybe implemented with any programming or scripting language such as C, C++, java, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a scripting language, such as JavaScript, VBScript or the like. For a basic introduction of cryptography, please review a text written by Bruce Schneider which is entitled “Applied Cryptography: Protocols Algorithms, And Source Code In C,” published by John Wiley & Sons (second edition, 1996), which is hereby incorporated by reference.

It should be appreciated that the particular implementations shown and described herein are illustrative of the invention and its best mode and are not intended to otherwise limit the scope of the present invention in any way. Indeed, for the sake of brevity, conventional wireless data transmission, transmitter, receivers, modulators, base station, data transmission concepts and other functional aspects of the systems (and components of the individual operating components of the systems) may not be described in detail herein. Furthermore, the connecting lines shown in the various figures contained herein are intended to represent exemplary functional relationships and/or physical couplings between the various elements. It also should be noted that many alternative or additional functional relationships or physical connections may be present in a practical electronic transaction or file transmission system. Additionally, where elements of the invention are described as communicating with, or in communication with, the invention contemplates direct communication between components or communicating through one or more communicating or connected components.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

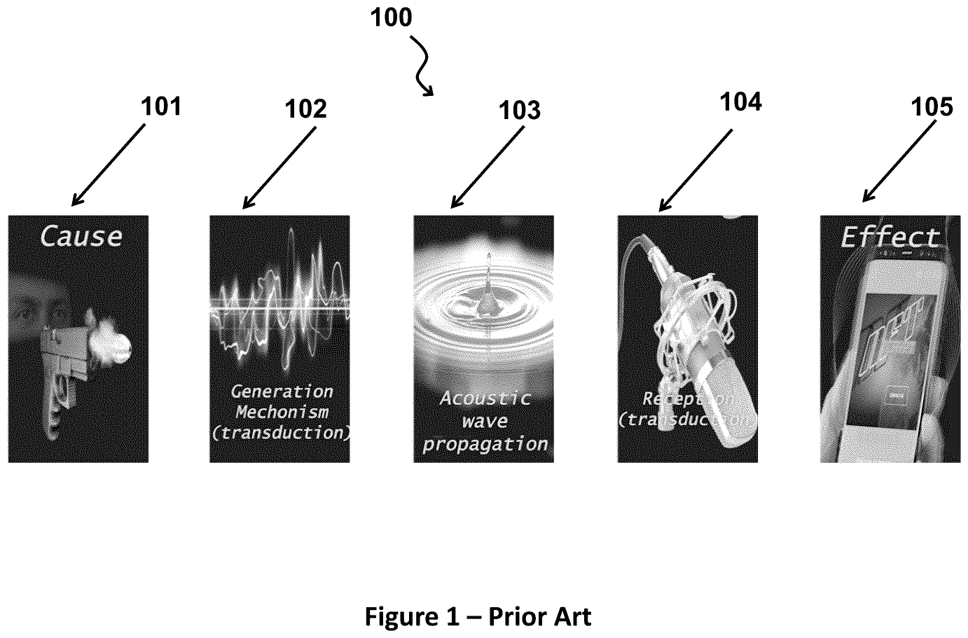

To simplify the description of the exemplary embodiment, we described for one of possible scenarios to illustrate the sequence of events taught in this invention. Further, it should be appreciated the sequence of events described herein is one just of many possible sequences and should be construed as a limit or all-encompassing operational use of the invention. FIG. 1 details the broad stages that occur during the operation of the invention. The invention is an automatic response system thus requiring a cause 101 or trigger to initiate the start of the process. Discharge of a firearm is one of the targeted causes this invention is intended to detect. Discharging a firearm generates 102 specific sound profiles 102 that are used today in monitoring systems. These monitoring systems utilize one form of transduction 104 to convert the propagating acoustic wave associated sound 103 profiles to a form for ease of detection. After detection, there is a predetermined step or sequence of steps 105. The present invention describes new approaches in the detection process and automatic responses not part of the current state of art

The present invention teaches a cooperative, distributed methodology for gunshot detection as source location not found in the art. The use of multiple source recording/capturing devices (such microphones) for source location is not new. Microphone arrays have been used for this purpose; however, the position of each microphone is typically known precisely relative to each other. Furthermore, their positions remain permanently fixed or relative fixed. In the preferred embodiment of the invention, the invention is implemented directly as a system on chip (SoC) intellectual property (IP) component within electronics of any commercially available smartphones. In this embodiment, there is a direct and known relationship between measurements from integrated sensors on the smartphone to measurements provided to on-board processor in the SoC implementation of this invention. An alternative embodiment, the SoC IP would be implemented as a separate dongle with its own integrated sensors and attached to the smartphone. Similarly, the relationship between the measurements from integrated sensors on the dongle to the smartphone is known by on-board processor in the SoC. The SoC maintains a “swarm-like” sharing of environmental and operational conditions amongst all SoC units communicating through a NvisiLink mesh network.

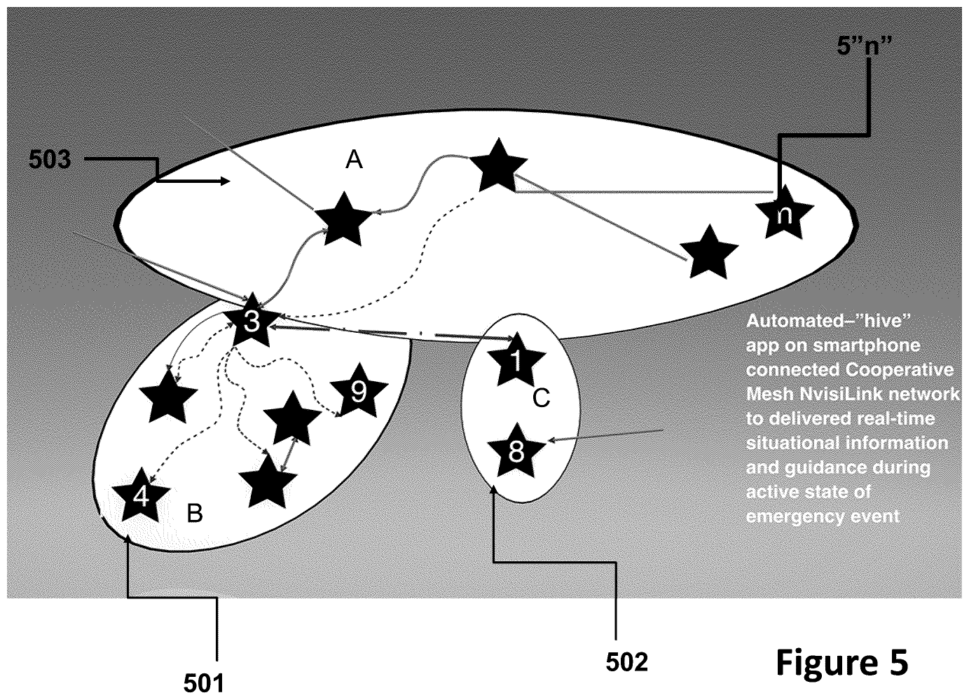

The NvisiLink mesh nodes of the present invention are able to simultaneously communication in small clusters of members without self-interference and perform inter-cluster communications via designated cluster heads such as depicted in FIG. 5. Member 3 (503) of cluster B is a designated cluster head as it can communicate directly with other members in different clusters within its range. For example, member 3 can communicate with member 1 of cluster C. Member 1 can communicate with member 8 of the same cluster. In this way, members of all clusters are updated with periodic real-time information. Upon detection of gunfire standard means of the state of the art, each member immediately sends out a beacon containing at least orientation information 1020, inertia information 1060, and GPS 1050 to other members and the central access point in the local area network for processing with their respective sensor fusion engines. This joint messaging mechanism represents a significant improvement in the state of the art as it infers the time difference of arrival between SoC devices detections of the gunfire from the access point (AP) perspective. In other words, the first arriving beacon to the access point originates from the device closest to the gunfire since the rf wave propagation speed is over five orders of magnitude faster than acoustic wave propagation speed. In a preferred embodiment, the AP would support dual modes of communications: WiFi 4-7 physical signaling operating cooperatively with NvisiLink mesh network in a local area network (LAN) coverage environment.

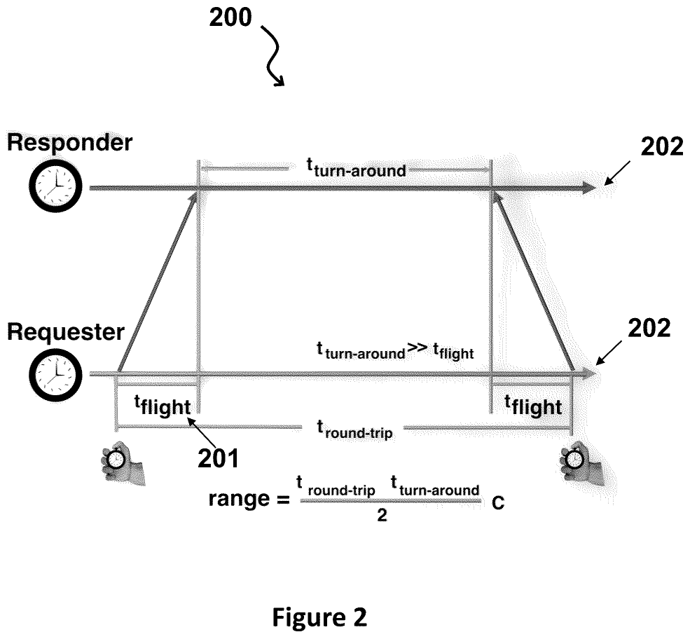

The present invention teaches training of deep learning neural network (DNN) 1200 to eliminate any non-direct line of sight measurements 1070 from concurrent two-way ranging calculation in FIG. 2 based on IM U measurements and orientation sensor data 1020 along with the current wireless channel state information indicating multipath at the receiver.

Further this invention teaches overlaying the absolute position of mobile SoC devices onto a floorplan containing fixed anchors (emitters 910, 930) strategically place 900 throughout the coverage area for monitoring and evacuation. Moreover, the invention further teaches downloading a digital version floorplan 1300 to all participating during an active event and indicating the area where the estimated source location of the gunfire on downloaded map.

In exemplary embodiments of the invention, the locations of the NvisiLink are made available to authorized staff, first responders, and law enforcement through the wireless LAN network while instructing via text and visual ques on the digital map of safe zones away from the source of the gunfire during an active threat scenario.

Further embodiments of the invention allow other external aid during an active threat scenario to track the source of the gunfire when acoustic measurements are insufficient. In a preferred implement, existing security camera feeds 1040 are used to track the location of the firearm and direct smartphone users away from harm.

We claim:

1. A system for cooperative wireless networking of a collection of sensor signal capture devices, including automated simultaneous multi-protocol wireless safety and response transmissions, the system comprising:
a. at least three distinct and separately located microphones within a coverage area;
b. at least one distinct real-time relative positioning apparatus for computing real-time relative positioning co-located with each of the microphones, wherein the co-located real-time relative positioning apparatus is in communication with the microphone to which the at least one distinct real-time relative positioning apparatus is co-located;
c. at least one distinct display unit for displaying images and textual data co-located with each of the microphones, wherein the co-located display unit is in communication with the microphone to which the at least one distinct display unit is co-located;
d. at least one local processor running a gunshot detection and classification algorithm on incoming transduced sound wave co-located with each microphone, wherein the at least one of the local processors is in communication with the microphone to which the at least one local processor is co-located;
e. at least one wireless transmission device running a first wireless transmission protocol co-located with each distinct microphone, wherein the wireless transmission device is capable of at least four simultaneous connections over a wireless medium without the need to a priori scheduling of the wireless medium, wherein the co-located wireless transmission device is in communication with the microphone to which the wireless transmission device is co-located;
f. at least one sensor device capable of measuring device orientation relative to an internal frame of reference co-located with each distinct microphone, wherein the co-located sensor device is in communication with microphone to which the sensor device is co-located;
g. at least a second wireless transmission device running a second wireless transmissions protocol co-located with each distinct microphone, wherein the wireless transmission device is capable of communicating with law enforcement personnel or first responders.

2. A system of claim 1, wherein the first wireless transmissions protocol facilitates at least four simultaneous connections over the wireless medium, wherein the four simultaneous connections is communicates with a digital chaos connected mesh network comprising of devices transmitting and receiving Digital Chaos signatures

3. A system of claim 1, wherein the real-time relative positioning apparatus is GPS receiver.

4. A system of claim 1, wherein the real-time relative positioning apparatus is a non-GPS receiver.

5. A system of claim 3, wherein the real-time relative positioning apparatus is one of a two-way ranging UWB or digital chaos enabled devices.

6. A system for having a wireless receiver, wherein the wireless receiver is configured for real-time coordinate transformation from frame of reference derived from time-difference of arrival of acoustic measurements to an equivalent coordinate system and frame of reference derive from time-difference of arrival of rf measurements, wherein the real-time coordinate transformation is computed using an onboard processor system of WLAN AP measuring the time-difference of arrival of rf measurements.

7. A wireless receiver of claim 6, wherein the real-time coordinate transformation is computed using an cloud based processor system using time-difference of arrival of rf measurements from WLAN AP.

8. A wireless receiver of claim 6, wherein the receiver is configured for eliminating multipath false peaks from two-way ranging calculations using real-time shared orientation data and measured wireless channel state information.

9. A wireless receiver of claim 8, where eliminating multipath false peaks is computed with an onboard processor at one of the receiving device participating in the two-way ranging procedure.

10. A wireless receiver of claim 8, wherein the receiver is configured to immediate transmission of a SOS beacon frame containing the device relative position and other situational awareness information to all active devices on the wireless medium when gunfire is detected at the device to preserve the time-difference of arrival information between devices.

11. A wireless receiver of claim 10, wherein other situational awareness information includes measurements from integrated IMU co-located with the microphone.

12. A wireless receiver of claim 10, wherein other situational awareness information includes images from camera at known locations in the coverage area.
